(19) United States
(12) Patent Application Publication
(10) Pub. No.: US 2022/0353493 A1
(43) Pub. Date: Nov. 3, 2022

(54) INFORMATION PROCESSING APPARATUS AND METHOD

(71) Applicant: SONY GROUP CORPORATION, Tokyo (JP)

(72) Inventors: Tsuyoshi KATO, Kanagawa (JP); Satoru KUMA, Tokyo (JP); Ohji NAKAGAMI, Tokyo (JP); Hiroyuki YASUDA, Saitama (JP); Koji YANO, Tokyo (JP)

(73) Assignee: SONY GROUP CORPORATION, Tokyo (JP)

(21) Appl. No.: 17/620,429

(22) PCT Filed: Jun. 11, 2020
(86) PCT No.: PCT/JP2020/023041

§ 371 Date: Dec. 17, 2021

(30) Foreign Application Priority Data
Jun. 25, 2019 (JP) 2019-117533

(51) Int. Cl. H04N 19/103; G06T 9/40; H04N 19/597

(52) U.S. Cl. CPC H04N 19/103; G06T 9/40; H04N 19/597

(57) ABSTRACT

The present disclosure relates to an information processing apparatus and a method for achieving scalability of the number of points in point cloud data. Encoded data of a point cloud representing a three-dimensional object as a point group is decoded, a tree structure using the positional information about the respective points constituting the point cloud is generated, and the number of nodes corresponding to the depth of the level of detail is selected for some or all of the levels of detail constituting the tree structure. The present disclosure can be applied to an information processing apparatus, an electronic apparatus, an information processing method, a program, or the like, for example.

### TECHNICAL FIELD

The present disclosure relates to information processing apparatuses and methods, and more particularly, to an information processing apparatus and a method that are designed to be capable of achieving scalability of the number of points in point cloud data.

### BACKGROUND ART

As a method for encoding 3D data representing a three-dimensional structure such as a point cloud, for example, there has been encoding using an octree, for example (see Non-Patent Document 1, for example). The use of an octree enables scalable decoding of geometry data in terms of resolution. For example, as a decoding process can be terminated at any desired level of detail (LoD), geometry data of any desired resolution can be easily generated.

Further, when the points are dense, it becomes possible to achieve not only scalability of resolution but also scalability of the number of points to be output, with the use of an octree. For example, by making the level of detail (LoD) to be decoded shallower (by terminating the decoding process at a higher level), it is possible to further reduce the number of points to be output. That is, the information amount of a point cloud can be reduced, and the load of output processing such as display can be reduced.

Conversely, by making the level of detail (LoD) to be decoded deeper (by performing the decoding process until reaching a lower level), the number of points to be output can be further increased. That is, a point cloud can more accurately represent a three-dimensional structure.

When the points are dense, such scalability of the number of points can be easily realized with the use of an octree. Accordingly, more appropriate decoding can be performed in a wider variety of circumstances.

### CITATION LIST

### Non-Patent Document

Non-Patent Document 1: R. Mekuria, Student Member IEEE, and K. Blom and P. Cesar, Members IEEE, “Design, implementation and Evaluation of a Point Cloud Codec for Tele-Immersive Video”, tcsvt_paper_submitted_february.pdf

### SUMMARY OF THE INVENTION

### Problems to be Solved by the Invention

However, in the case of data formed primarily with sparse points, such as light detection and ranging (LiDAR) data, for example, the number of points does not change greatly even if the decoding process is terminated at any level of detail (LoD). Therefore, in such a case, it is difficult to achieve scalability of the number of points by a conventional method.

The present disclosure has been made in view of such circumstances, and aims to achieve scalability of the number of points in point cloud data.

### Solutions to Problems

An information processing apparatus of one aspect of the present technology is an information processing apparatus that includes: a positional information decoding unit that decodes encoded data of a point cloud representing a three-dimensional object as a point group, and generates a tree structure using positional information about the respective points constituting the point cloud; and a selection unit that selects the number of nodes corresponding to a depth of a level of detail with respect to some or all of the levels of detail constituting the tree structure.

An information processing method of one aspect of the present technology is an information processing method that includes: decoding encoded data of a point cloud representing a three-dimensional object as a point group, and generating a tree structure using positional information about the respective points constituting the point cloud; and selecting the number of nodes corresponding to a depth of a level of detail with respect to some or all of the levels of detail constituting the tree structure.

In the information processing apparatus and method of one aspect of the present technology, encoded data of a point cloud representing a three-dimensional object as a point group is decoded, a tree structure using the positional information about the respective points constituting the point cloud is generated, and the number of nodes corresponding to the depth of the level of detail is selected with respect to some or all of the levels of detail constituting the tree structure.

### BRIEF DESCRIPTION OF DRAWINGS

FIG. 1 is a diagram for explaining an octree of sparse points.

FIG. 2 is a diagram for explaining scalability the number of points.

FIG. 3 is a chart summarizing various kinds of methods for achieving scalability of the number of points.

FIG. 4 is a block diagram showing a typical example configuration of a point selection device.

FIG. 5 is a flowchart for explaining an example flow in a point selection process.

FIG. 6 is a block diagram showing a typical example configuration of an encoding device.

FIG. 7 is a flowchart for explaining an example flow in an encoding process.

FIG. 8 is a block diagram showing a typical example configuration of a decoding device.

FIG. 9 is a flowchart for explaining an example flow in a decoding process.

FIG. 10 is a block diagram showing a typical example configuration of a computer.

### MODE FOR CARRYING OUT THE INVENTION

The following is a description of modes for carrying out the present disclosure (the modes will be hereinafter referred to as embodiments). Note that explanation will be made in the following order.

1. Scalability of the number of points

2. First embodiment (a point selection device)

3. Second embodiment (an encoding device)

4. Third embodiment (a decoding device)

5. Notes

### 1. Scalability of the Number of Points

<Documents and the Like that Support Technical Contents and Terms>

The scope disclosed in the present technology includes not only the contents disclosed in the embodiments but also the contents disclosed in the following non-patent documents that were known at the time of filing.

Non-Patent Document 1: (mentioned above)

Non-Patent Document 2: (mentioned above)

Non-Patent Document 3: TELECOMMUNICATION STANDARDIZATION SECTOR OF ITU (International Telecommunication Union), “Advanced video coding for generic audiovisual services”, H.264, April 2017

Non-Patent Document 4: TELECOMMUNICATION STANDARDIZATION SECTOR OF ITU (International Telecommunication Union), “High efficiency video coding”, H.265, December 2016

Non-Patent Document 5: Jianle Chen, Elena Alshina, Gary J. Sullivan, Jens-Rainer, and Jill Boyce, “Algorithm Description of Joint Exploration Test Model 4”, JVET-G1001_v1, Joint Video Exploration Team (JVET) of ITU-T SG 16 WP 3 and ISO/IEC JTC 1/SC 29/WG 11 7th Meeting: Torino, IT, 13-21 July 2017

Non-Patent Document 6: Ohji Nakagami, Satoru Kuma, “[G-PCC] Spatial scalability support for G-PCC”, ISO/IEC JTC1/SC29/WG11 MPEG2019/m47352, March 2019, Geneva, CH

That is, the contents disclosed in the non-patent documents listed above are also the basis for determining the support requirements. For example, even when the Quad-Tree Block Structure disclosed in Non-Patent Document 4 and the Quad Tree Plus Binary Tree (QTBT) Block Structure disclosed in Non-Patent Document 5 are not directly disclosed in the embodiments, those structures are within the scope of the present technology, and satisfy the support requirements of the claims. Further, the technical terms such as parsing, syntax, and semantics are also within the scope of disclosure of the present technology, and satisfy the support requirements of the claims, even when those technical terms are not directly described, for example.

<Point Cloud>

There have been 3D data such as point clouds that represent three-dimensional structures with positional information, attribute information, and the like about point clouds, and meshes that are formed with vertices, edges, and planes, and define three-dimensional shapes using polygonal representations.

In the case of a point cloud, for example, a three-dimensional structure (a three-dimensional object) is expressed as a set (a point cloud) of a large number of dots (also referred to as points). The data of a point cloud (also referred to as point cloud data) is formed with positional information and attribute information (colors and the like, for example) about the respective dots (the respective points). The positional information (also referred to as geometry data) is information indicating the positions (coordinates, for example) of the points. The attribute information (also referred to as attribute data) includes any appropriate information regarding the points, such as the colors, the reflectances, and the normal directions of the points, for example. As described above, the data structure of a point cloud is relatively simple, and any desired three-dimensional structure can be expressed with a sufficiently high accuracy with the use of a sufficiently large number of points.

<Quantization of Positional Information Using Voxels>

Since the data amount of such point cloud data is relatively large, an encoding method using voxels has been suggested to reduce the data amount by encoding and the like. A voxel is a three-dimensional region for quantizing positional information.

That is, a three-dimensional region containing a point cloud is divided into small three-dimensional regions called voxels, and each voxel indicates whether or not points are contained therein. With this arrangement, the positions of the respective points are quantized in voxel units. Accordingly, point cloud data is transformed into such data of voxels (also referred to as voxel data), so that an increase in the amount of information can be prevented (typically, the amount of information can be reduced).

<Octree>

Further, construction of an octree using such voxel data has been suggested. An octree is a tree-structured version of voxel data. The value of each bit of the lowest nodes of this octree indicates the presence or absence of a point in each voxel. For example, a value “1” indicates a voxel containing points, and a value “0” indicates a voxel containing no points. In the octree, one node corresponds to eight voxels. That is, each node of the octree is formed with 8-bit data, and the eight bits indicate the presence or absence of points in eight voxels.

Further, a higher node of the octree indicates the presence or absence of points in a region in which the eight voxels corresponding to the lower node belonging to the node are combined into one. That is, the higher node is generated by gathering the voxel information about the lower node. Note that, when the value of a node is “0”, or where all the eight corresponding voxels contain no points, the node is deleted.

In this manner, a tree structure (an octree) formed with nodes whose values are not “0” is constructed. That is, an octree can indicate the presence or absence of points in voxels at each resolution. Accordingly, voxel data is transformed into an octree and is then encoded so that the voxel data at various resolutions can be more easily restored at the time of decoding. That is, voxel scalability can be achieved more easily.

Furthermore, as the nodes having the value “0” are omitted as described above, the voxels in the regions without points can be lowered in resolution. Thus, an increase in the amount of information can be further prevented (typically, the amount of information can be reduced).

<Scalability of the Number of Points>

As described above, the use of an octree enables scalable decoding of geometry data in terms of resolution. For example, as a decoding process can be terminated at any desired level of detail (LoD), geometry data of any desired resolution can be easily generated.

Further, if the points are dense (or when there are many points in the vicinity), the number of points decreases at a higher level and increases at a lower level in the octree. That is, as an octree is adopted, scalability of the number of points to be output also becomes possible. For example, by making the level of detail (LoD) to be decoded shallower (by terminating the decoding process at a higher level), it is possible to further reduce the number of points to be output.

The number of points affects the processing load related to outputting (display, for example) of point cloud data. For example, when a point cloud is rendered on a screen, the point cloud data is transferred from a central processing unit (CPU) to a graphics processing unit (CPU). As the number of points increases, the amount of information increases. That is, the cost of transfer from the CPU to the CPU increases.

Therefore, by achieving scalability of the number of points as described above, it becomes possible to control the transfer cost. That is, the load of output processing such as display can be controlled.

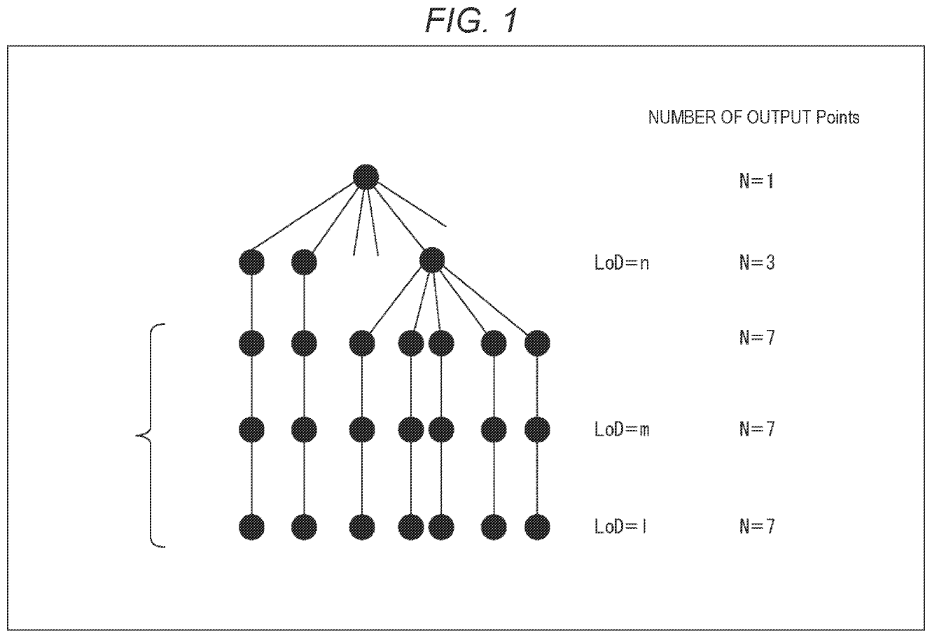

However, in the case of data formed primarily with sparse points, such as light detection and ranging (LiDAR) data, for example, the number of points does not change greatly even if the decoding process is terminated at any level of detail (LoD). When a point cloud is formed with sparse points, the octree has a configuration as shown in FIG. 1, for example. In the case of FIG. 1, black circles represent the nodes of an octree. Each black circle at the lowermost level represents a leaf. Each line between the black circles represents a parent-child relationship.

Since each point is sparse in this case, the number N of points does not change at the third or lower level of detail from the top (N=7 at any level of detail). Therefore, in such a case, it is difficult to achieve scalability of the number of points by a conventional method. That is, it is difficult to control the load of output processing such as display by controlling the level of detail to be decoded.

<Selection of Points to be Output>

In view of the above, the number of points to be output is limited in accordance with the depth of the current level of detail. For example, encoded data of a point cloud representing a three-dimensional object as a point group is decoded, a tree structure using the positional information about the respective points constituting the point cloud is generated, and the number of nodes corresponding to the depth of the level of detail is selected for some or all of the levels of detail constituting the tree structure.

For example, an information processing apparatus includes: a positional information decoding unit that decodes encoded data of a point cloud representing a three-dimensional object as a point group, and generates a tree structure using the positional information about the respective points constituting the point cloud; and a selection unit that selects the number of nodes corresponding to the depth of each level of detail for some or all of the levels of detail constituting the tree structure.

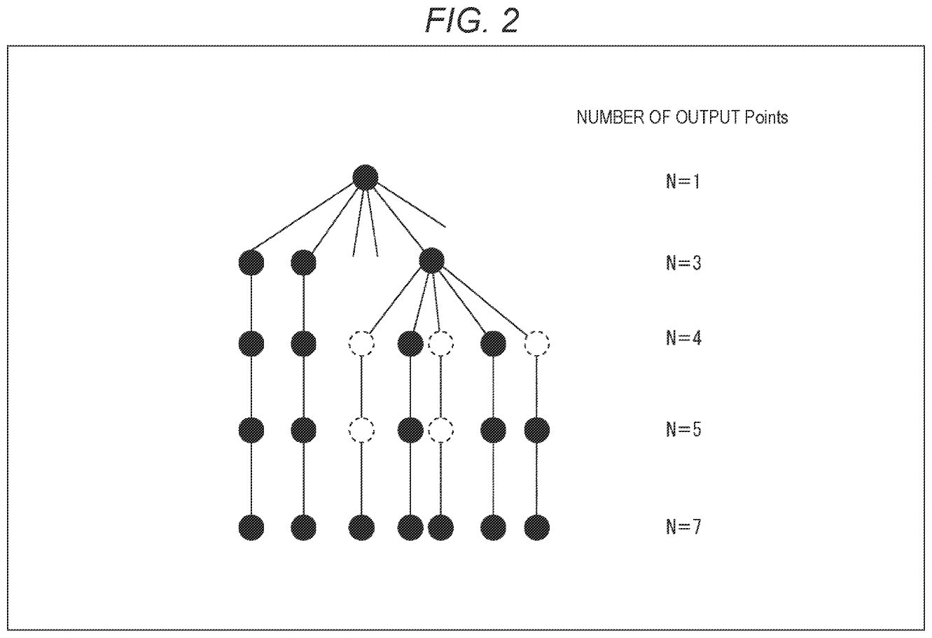

For example, for the octree shown in FIG. 1, the points to be output are selected as shown in FIG. 2 (in other words, the points to be output are reduced). In this case, a node indicated by a white circle drawn with a dashed line in the drawing represents an eliminated node. That is, in the case of FIG. 2, the number N of output points at each level of detail is N=1, 3, 4, 5, and 7 in this order from the highest level. Accordingly, by controlling the level of detail to be decoded, it becomes possible to achieve scalability of the number of points to be output.

<Specific Examples of Point Selection Methods>

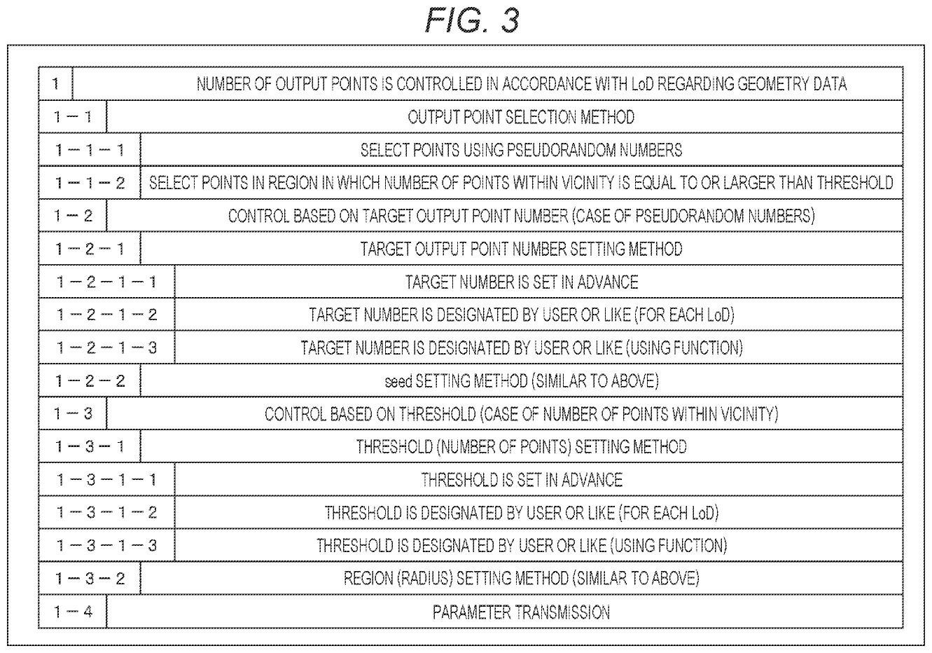

That is, the number of points to be output is controlled in accordance with the level of detail (LoD) to be decoded for geometry data, as in method 1 shown in the uppermost row in the table in FIG. 3. In this manner, it is possible to achieve scalability of the number of points as described above. For example, as in the example shown in FIG. 2, nodes may be selected at the current level of detail, so that the number of nodes to be selected in the case of the first level of detail in the octree becomes larger than the number of nodes to be selected in the case of the second level of detail, which is shallower than the first level of detail. That is, a larger number of nodes may be selected at a deeper level of detail in the octree. In other words, the number of nodes to be selected may monotonically increase in a direction from a shallower level of detail toward a deeper level of detail in the octree.

Note that the method for selecting the points to be output is any appropriate method, like method 1-1 shown in the second row from the top of the table in FIG. 3. For example, as in method 1-1-1 shown in the third row from the top of the table in FIG. 3, points may be selected with the use of pseudorandom numbers. With the use of pseudorandom numbers, various (almost random) selections can be performed, and similar point selections can be performed (or the same points can be selected) on both the encoding side and the decoding side.

Also, as in method 1-1-2 shown in the fourth row from the top of the table in FIG. 3, the points at which the number of points within a nearby region of a predetermined size is equal to or larger than a threshold may be selected, without the use of pseudorandom numbers. That is, points in a denser state may be preferentially selected. In the case of this method, similar point selections can also be performed (the same points can be selected) on both the encoding side and the decoding side.

Furthermore, when point selection is performed with pseudorandom numbers as in method 1-1-1, for example, a target value of the number of points to be output (a target output point number) may be set, and point selection (using pseudorandom numbers) may be performed until the number of output points reaches the target value, as in method 1-2 shown in the fifth row from the of the table in FIG. 3.

The method for setting the target output point number in that case is any appropriate method, as in method 1-2-1 shown in the sixth row from the top of the table in FIG. 3. For example, target output point numbers may be set beforehand for the respective levels of detail, as in method 1-2-1-1 shown in the seventh row from the top of the table in FIG. 3. That is, the target output point number corresponding to the current level of detail may be set among the predetermined target output point numbers for the respective levels of detail, and point selection using pseudorandom numbers may be performed until the target output point number is reached.

Further, as in method 1-2-1-2 shown in the eighth row from the top of the table in FIG. 3, for example, target output point numbers may be designated for the respective levels of detail by a user, an application, or the like. That is, the target output point number corresponding to the current level of detail may be set among the designated target output point numbers for the respective levels of detail, and point, selection using pseudorandom numbers may be performed until the target output point number is reached.

Furthermore, as in method 1-2-1-3 shown in the ninth row from the top of the table in FIG. 3, for example, a target output point number may be designated with a function by a user, an application, or the like. That is, the target output point number corresponding to the current level of detail may be derived with the use of the designated function, and point selection using pseudorandom numbers may be performed until the target output point number is reached.

Note that the method for controlling the number of output points when points are selected with the use of pseudorandom numbers is any appropriate method, and is not limited to these examples. For example, occurrence probabilities may be weighted in accordance with the depths of the levels of detail, and the occurrence probability weighted in accordance with the current level of detail may be reflected in the selection of points.

Note that, when seed information is used in generation of pseudorandom numbers, the method for setting the seed information may be any appropriate method, as in method 1-2-2 shown in the tenth row from the top of the table in FIG. 3. For example, the seed information may be set in advance, as in the case of method 1-2-1-1. Also, the seed information may be set by a user, an application, or the like, as in the case of method 1-2-1-2. Further, a predetermined function for deriving the seed information may be designated by a user, an application, or the like, as in method 1-2-1-3.

Furthermore, when the points at which the number of points within a nearby region is equal to or larger than a threshold are selected as in method 1-1-2, for example, the threshold may be controlled so that the point number corresponding to the depth of the level of detail selected, as in method 1-3 shown in the eleventh row from the top of the table in FIG. 3.

The method for setting the threshold in that case is any appropriate method, as in method 1-3-1 shown in the twelfth row from the top of the table in FIG. 3. For example, thresholds may be set beforehand for the respective levels of detail, as in method 1-3-1-1 shown in the thirteenth row from the top of the table in FIG. 3. That is, the threshold corresponding to the current level of detail may be set among the predetermined thresholds for the respective levels of detail, and the points at which the number of points is equal to or larger than the threshold within a nearby region may be selected.

Further, as in method 1-3-1-2 shown in the fourteenth row from the top of the table in FIG. 3, for example, thresholds may be designated for the respective levels of detail by a user, an application, or the like. That is, the threshold corresponding to the current level of detail may be set among the designated thresholds for the respective levels of detail, and the points at which the number of points is equal to or larger than the threshold within a nearby region may be selected.

Furthermore, as in method 1-3-1-3 shown in the fifteenth row from the top of the table in FIG. 3, for example, thresholds may be designated with a function by a user, an application, or the like. That is, the threshold corresponding to the current level of detail may be derived with the use of the designated function, and the points at which the number of points is equal to or larger than the threshold within a nearby region may be selected.

Further, as in method 1-3-2 shown in the sixteenth row from the top of the table in FIG. 3, the method for setting the range (radius) of the nearby region is any appropriate method. For example, this radius may be set in advance, as in the case of method 1-3-1-1. Also, this radius may be set by a user, an application, or the like, as in the case of method 1-3-1-2. Furthermore, as in method 1-3-1-3, a predetermined function for deriving the radius may be designated by a user, an application, or the like.

Note that the parameters related to point selection may be transmitted from the encoding side, to the decoding side, as in method 1-4 shown in the seventeenth row from the top of the table in FIG. 3.

For example, when point selection is performed with the use of pseudorandom numbers, seed information to be used in generation of the pseudorandom numbers may be incorporated as metadata into a bitstream, for example, and be transmitted from the encoding side to the decoding side. That is, in this case, the decoding side derives pseudorandom numbers, using the seed information supplied from the encoding side.

Alternatively, the target value of the number of output points described above may be incorporated as metadata into a bitstream, for example, and be transmitted from the encoding side to the decoding side. That is, in this case, the decoding side selects the points to be output, until the target value of the number of output points supplied from the encoding side is reached.

Further, when the points at which the number of points within a nearby region is equal to or larger than a threshold are selected, for example, the threshold may be incorporated as metadata into a bitstream, for example, and be transmitted from the encoding side to the decoding side. That is, in this case, the decoding side performs point selection, using the threshold supplied from the encoding side.

Alternatively, when the points at which the number of points within a nearby region is equal to or larger than a threshold are selected, for example, the range (radius) of the nearby region may be incorporated as metadata into a bitstream, for example, and be transmitted from the encoding side to the decoding side. That is, in this case, the decoding side sets the nearby region, in accordance with the radius supplied from the encoding side.

As described above, the use of various methods is allowed for selecting points to be output, so that scalability of the number of points can be achieved in a wider variety of point cloud data.

### 2. First Embodiment

Point Selection Device

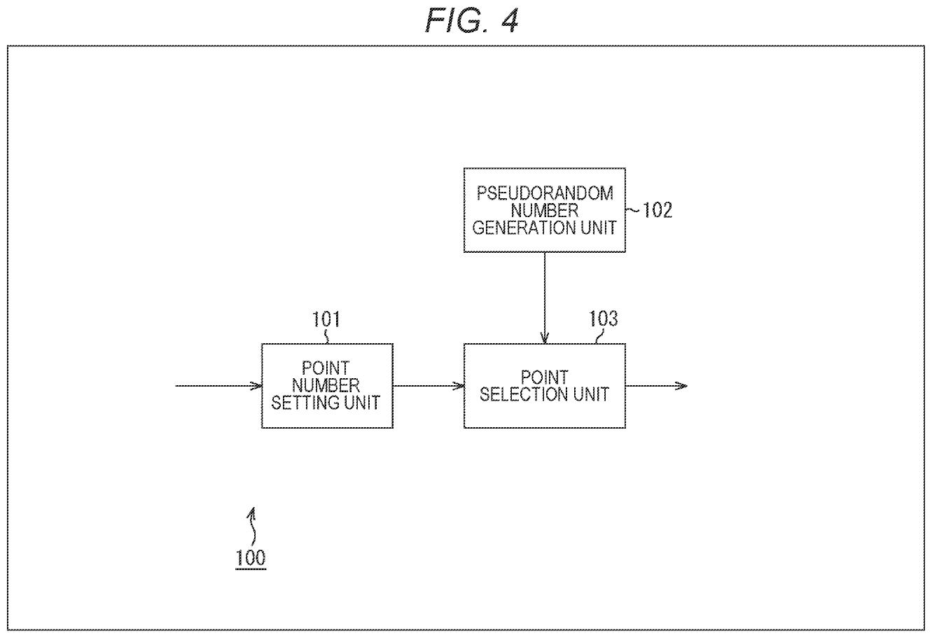

FIG. 4 is a block diagram showing a typical example configuration of a point selection device as an embodiment of a signal processing device to which the present technology is applied. A point selection device 100 shown in FIG. 4 is a device that controls the number of points to be output for geometry data, in accordance with the level of detail (LoD) to be decoded. By doing so, the point selection device 100 can achieve scalability of the number of points as described above.

Note that a case where the point selection device 100 selects points using pseudorandom numbers is described herein.

FIG. 4 shows the principal components and aspects such as processing units and data flows, but FIG. 4 does not necessarily show all the components and aspects. That is, in the point selection device 100, there may be a processing unit that is not shown as a block in FIG. 4, or there may be a processing or data flow that is not shown as an arrow or the like in FIG. 4.

As shown in FIG. 4, the point selection device 100 includes a point number setting unit 101, a pseudorandom number generation unit 102, and a point selection unit 103.

The point number setting unit 101 performs a process related to the setting of the number of points to be output. For example, the point number setting unit 101 acquires geometry data (geometry data transformed into an octree) that is input to the point selection device 100. The point number setting unit 101 sets the number of points to be output for the geometry data, in accordance with the current level of detail (LoD).

For example, the point number setting unit 101 sets the target output point number corresponding to the current level of detail, using method 1-2-1, method 1-2-1-1, method 1-2-1-2, method 1-2-1-3, or the like shown in FIG. 3.

The point number setting unit 101 supplies the set target output point number, together with the geometry data, to the point selection unit 103.

The pseudorandom number generation unit 102 performs a process related to generation of pseudorandom numbers. For example, the pseudorandom number generation unit 102 generates the pseudorandom numbers to be used in point selection.

For example, the pseudorandom number generation unit 102 sets the pseudorandom numbers, using method 1-2-2 or the like shown in FIG. 3 (that is, using seed information). The method for setting this seed information is as described above with reference to FIG. 3.

The pseudorandom number generation unit 102 supplies the generated pseudorandom numbers to the point selection unit 103.

The point selection unit 103 performs a process related to selection of points to be output. For example, the point selection unit 103 acquires the geometry data and the target output point number supplied from the point number setting unit 101. The point selection unit 103 also acquires the pseudorandom numbers supplied from the pseudorandom number generation unit 102.

The point selection unit 103 selects the points to be output, using these pieces of information. For example, the point selection unit 103 selects points from the geometry data until the target output point number is reached, using the pseudorandom numbers (that is, using method 1-1-1 shown in FIG. 3). That is, the point selection unit 103 selects, from some or all of the levels of detail in the octree of the geometry data, the number of nodes constituting the octree, the number of nodes corresponding to the depth of the level of detail.

The point selection unit 103 outputs (the geometry data of) the selected points. By doing so, the point selection unit 103 can select and output the number of points corresponding to (the depth of) the current level of detail. That is, scalability of the number of points can be achieved.

Note that the point selection device 100 may of course perform point selection, using method 1-1-2 shown in FIG. 3. That is, the point selection device 100 may select the points at which the number of points within a nearby region is equal to or larger than a threshold (corresponding to the current level of detail).

In that case, a processing unit that sets the nearby region, the threshold, and the like is only required to be provided, instead of the point number setting unit 101 and the pseudorandom number generation unit 102.

Note that each of these processing units (from the point number setting unit 101 to the point selection unit 103) of the point selection device 100 has any appropriate configuration. For example, each processing unit may be formed with a logic circuit that performs the processes described above. Further, each processing unit may also include a CPU, ROM, RAM, and the like, for example, and execute a program using them, to perform the processes described above. Each processing unit may of course have both configurations, and perform some of the processes described above with a logic circuit, and the others by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Flow in a Point Selection Process>

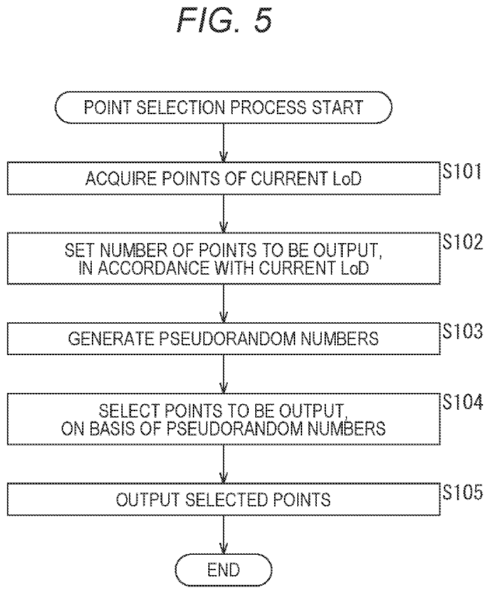

The point selection device 100 selects points by performing a point selection process. An example flow in this point selection process is now described, with reference to the flowchart shown in FIG. 5.

When the point selection process is started, the point number setting unit 101 acquires the geometry data (geometry data transformed into an octree) of the current level of detail (LoD) in step S101.

In step S102, the point number setting unit 101 sets (the target value of) the number of points to be output, in accordance with the current level of detail (LoD).

In step S103, the pseudorandom number generation unit 102 sets pseudorandom numbers.

In step S104, the point selection unit 103 selects the points to be output, using the pseudorandom numbers generated in step S103. At this stage, the point selection unit 103 sets the number of points set in step S102 as the target value, and selects the points to be output until the target value is reached.

In step S105, the point selection unit 103 outputs the points selected in step S104. When the process in step S105 is completed, the point selection process comes to an end.

By performing the point selection process as described above, the point selection device 100 can select and output the number of points corresponding to the current level of detail. Thus, scalability of the number of points can be more easily achieved.

### 3. Second Embodiment

<Encoding Device>

The present technology can be applied to any appropriate devices. For example, the present technology can also be applied to devices other than the point selection device 100 described above with reference to FIG. 4.

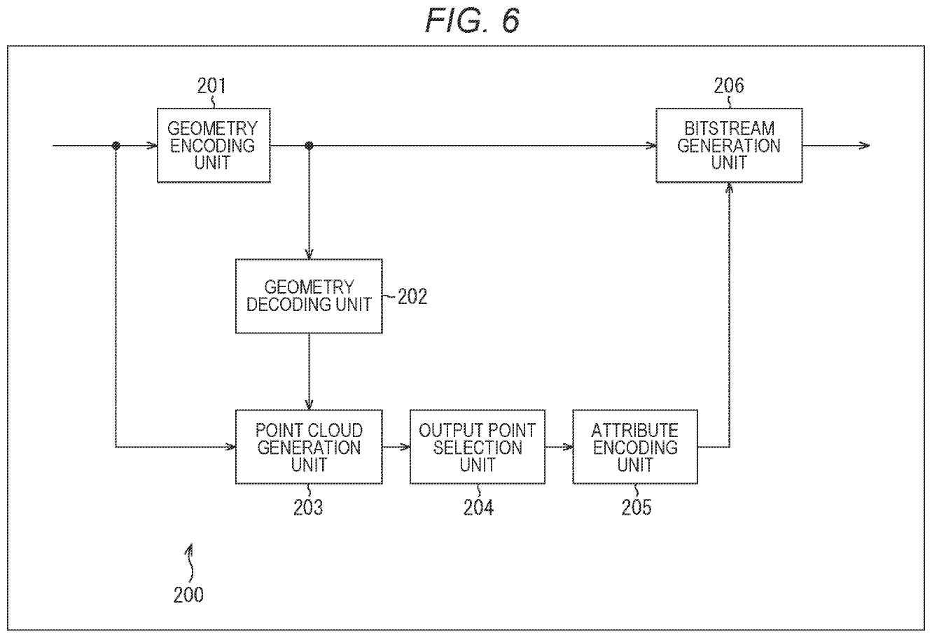

FIG. 6 is a block diagram showing a typical example configuration of an encoding device that is an embodiment of a signal processing device to which the present technology is applied. This encoding device 200 is a device that encodes 3D data such as a point cloud, using voxels and an octree.

Note that FIG. 6 shows the principal components and aspects such as processing units and a data flow, but FIG. 6 does not necessarily show all the components and aspects. That is, in the encoding device 200, there may be a processing unit that is not shown as a block in FIG. 6, or there may be a process or data flow that is not shown as an arrow or the like in FIG. 6.

As shown in FIG. 6, the encoding device 200 includes a geometry encoding unit 201, a geometry decoding unit 202, a point cloud generation unit 203, an output point selection unit 204, an attribute encoding unit 205, and a bitstream generation unit 206.

The geometry encoding unit 201 performs a process related to encoding of geometry data. For example, the geometry encoding unit 201 acquires the geometry data of point cloud data that is input to the encoding device 200. The geometry encoding unit 201 encodes the geometry data, to generate encoded data. That is, the geometry encoding unit 201 encodes an octree using the geometry data of each of the points constituting a point cloud, and generates the encoded data. The geometry encoding unit 201 supplies the generated encoded data to the geometry decoding unit 202 and the bitstream generation unit 206.

The geometry decoding unit 202 performs a process related to decoding of the encoded data of the geometry data. For example, the geometry decoding unit 202 acquires the encoded data of the geometry data supplied from the geometry encoding unit 201. The geometry decoding unit 202 decodes the encoded data by the decoding method compatible with the encoding method used in the geometry encoding unit 201, and generates (restores) geometry data. That is, the geometry decoding unit 202 decodes the encoded data of the point cloud, and generates a tree structure (an octree) using the geometry data of the respective points constituting the point cloud. The geometry decoding unit 202 supplies the generated geometry data (octree) to the point cloud generation unit 203.

The point cloud generation unit 203 performs a process related to generation of point cloud data. For example, the point cloud generation unit 203 acquires the attribute data of point cloud data that is input to the encoding device 200. The point cloud generation unit 203 also acquires the geometry data supplied from the geometry decoding unit 202.

There are cases where the geometry data changes due to processing such as encoding and decoding (for example, the points might increase or decrease, or move in some cases). That is, the geometry data supplied from the geometry decoding unit 202 might be different from the geometry data before encoded by the geometry encoding unit 201 an some cases.

Therefore, the point cloud generation unit 203 performs a process of matching the attribute data with the geometry data (the decoding result) (this process is also referred to as the recoloring process). That is, the point cloud generation unit 203 updates the attribute data so as to correspond to the update of the geometry data. The point cloud generation unit 203 supplies the geometry data and the updated attribute data (the attribute data corresponding to the geometry data (the decoding result)) to the output point selection unit 204.

The output point selection unit 204 performs a process related to selection of points to be output. For example, the output point selection unit 204 acquires the geometry data and the attribute data supplied from the point cloud generation unit 203.

The output point selection unit 204 selects the number of points corresponding to the current level of detail, with respect to the geometry data. That is, the output point selection unit 204 selects the number of nodes corresponding to the depth of the level of detail in some or all of the levels of detail in the octree of the geometry data.

The output point selection unit 204 basically has a configuration similar to that of the point selection device 100 (FIG. 4), and performs processes similar to those (FIG. 5) to be performed by the point selection device 100. The output point selection unit 204 can use the various methods described above with reference to FIG. 3. Thus, the output point selection unit 204 can achieve scalability of the number of points.

Note that the output point selection unit 204 not only selects points with respect to the geometry data, but also selects attribute data. That is, the output point selection unit 204 performs point selection with respect to the geometry data like the point selection device 100 described above, and also selects the attribute data corresponding to the selected points (geometry data).

The output point selection unit 204 supplies the attribute data corresponding to the points selected in this manner, to the attribute encoding unit 205.

The attribute encoding unit 205 performs a process related to encoding of attributes. For example, the attribute encoding unit 205 acquires the attribute data supplied from the output point selection unit 204. The attribute encoding unit 205 also encodes the attribute data by a predetermined method, and generates encoded data of the attribute data. The encoding method used herein may be any appropriate method. The attribute encoding unit 205 supplies the generated encoded data of the attribute data to the bitstream generation unit 206.

The bitstream generation unit 206 performs a process related to generation of a bitstream. For the bitstream generation unit 206 acquires the encoded data of the geometry supplied from the geometry encoding unit 201. The bitstream generation unit 206 also acquires the encoded data of the attribute data supplied from the attribute encoding unit 205. The bitstream generation unit 206 generates a bitstream containing these sets of encoded data. Note that the bitstream generation unit 206 can also incorporate any desired information as metadata into the bitstream, as necessary. The bitstream generation unit 206 outputs the generated bitstream to the outside of the encoding device 200.

Note that each of these processing units (from the geometry encoding unit 201 to the bitstream generation unit 206) of the encoding device 200 has any appropriate configuration. For example, each processing unit may be formed with a logic circuit that performs the processes described above. Further, each processing unit may also include a CPU, ROM, RAM, and the like, for example, and execute a program using their, to perform the processes described above. Each processing unit may of course have both configurations, and perform some of the processes described above with a logic circuit, and the others by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Flow in an Encoding Process>

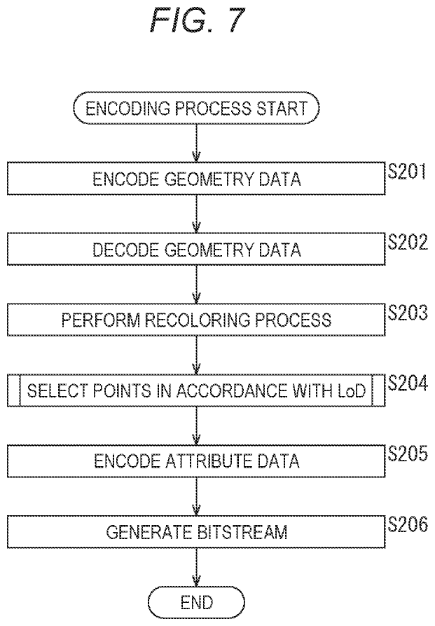

This encoding device 200 encodes point cloud data by performing an encoding process. An example flow in this encoding process is now described, with reference to the flowchart shown in FIG. 7.

When the encoding process is started, the geometry encoding unit 201 encodes geometry data, to generate encoded data of the geometry data in step S201.

In step S202, the geometry decoding unit 202 decodes the encoded data generated in step S201, to generate (restore) geometry data.

In step S203, the point cloud generation unit 203 performs a recoloring process, to make the attribute data correspond to the geometry data generated in step S202.

In step S204, the output point selection unit 204 performs a point selection process, to select the number of points corresponding to the current level of detail (LoD). Note that this point selection process can be performed in a flow similar to the flowchart shown in FIG. 5, for example.

Also, when points are selected with respect to the geometry data, the output point selection unit 204 further selects the attribute data corresponding to the selected points (geometry data).

In step S205, the attribute encoding unit 205 encodes the attribute data subjected to the recoloring process in step S203.

In step S206, the bitstream generation unit 206 generates and outputs a bitstream containing the encoded data of the geometry data generated in step S201 and the encoded data of the attribute data generated in step S205.

When the process in step S206 is completed, the encoding process comes to an end.

By performing the encoding process as described above, the encoding device 200 can select the number of points corresponding to the current level of detail (LoD). Thus, the encoding device 200 can achieve scalability of the number of points.

### 4. Third Embodiment

<Decoding Device>

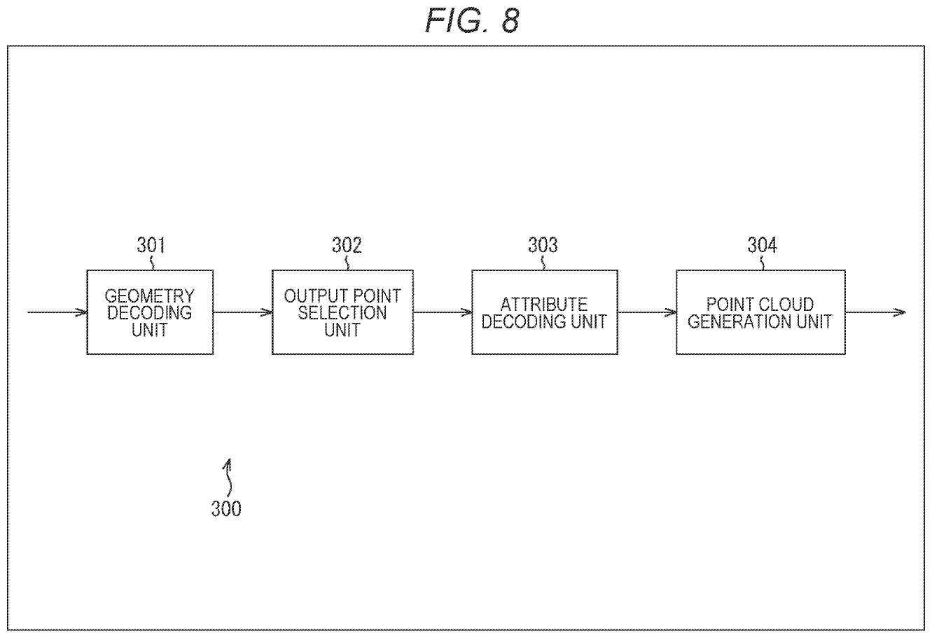

The present technology can also be applied to a decoding device, for example. FIG. 8 is a block diagram showing a typical example configuration of a decoding device that is an embodiment of a signal processing device to which the present technology is applied. This decoding device 300 is a device that decodes encoded data that has been obtained by encoding 3D data such as a point cloud with the use of voxels and an octree. This decoding device 300 is compatible with the encoding device 200 (FIG. 6), for example, and can correctly decode encoded data generated by the encoding device 200.

Note that FIG. 8 shows the principal components and aspects such as processing units and a data flow, but FIG. 8 does not necessarily show all the components and aspects. That is, in the decoding device 300, there may be a processing unit that is not shown as a block in FIG. 8, or there may be a process or data flow that is not indicated by an arrow or the like in FIG. 8.

As shown in FIG. 8, the decoding device 300 includes a geometry decoding unit 301, an output point selection unit 302, an attribute decoding unit 303, and a point cloud generation unit 304.

The geometry decoding unit 301 performs a process related to decoding of geometry data. For example, the geometry decoding unit 301 acquires encoded data of point cloud data that is input to the decoding device 300. This encoded data includes both geometry data and attribute data.

The geometry decoding unit 301 decodes the encoded data of the geometry data, to generate geometry data. That is, the geometry decoding unit 301 decodes the encoded data of the point cloud, and generates an octree using the geometry data of the respective points constituting the point cloud. The geometry decoding unit 301 supplies the generated geometry data and the encoded data of the attribute data to the output point selection unit 302.

The output point selection unit 302 performs a process related to selection of output points. For example, the output point selection unit 302 acquires the geometry data supplied from the geometry decoding unit 301, and the encoded data of the attribute data.

The output point selection unit 302 also selects the number of points corresponding to the current level of detail, with respect to the geometry data. That is, the output point selection unit 302 selects the number of nodes corresponding to the depth of the level of detail in some or all of the levels of detail in the octree. The output point selection unit 302 basically has a configuration similar to that of the point selection device 100 (FIG. 4), and performs processes similar to those (FIG. 5) to be performed by the point selection device 100. That is, the output point selection unit 302 can use the various methods described above with reference to FIG. 3. Thus, the output point selection unit 302 can achieve scalability of the number of points.

Note that, with respect to the attribute data, the points to be output have been selected in the encoding device 200. Accordingly, the output point selection unit 302 skips the selection of points with respect to the attribute data. The output point selection unit 302 supplies the geometry data corresponding to the selected points and the encoded data of the attribute data to the attribute decoding unit 303.

The attribute decoding unit 303 performs a process related to attribute decoding. For example, the attribute decoding unit 303 acquires the encoded data of the attributes supplied from the output point selection unit 302. The attribute decoding unit 303 also acquires the geometry data supplied from the output point selection unit 302.

The attribute decoding unit 303 decodes the acquired encoded data, and generates (restores) attribute data. As described above, with respect to the attribute data generated by the attribute decoding unit 303, the points to be output have already been selected in the encoding device 200. That is, the attribute data corresponds to the geometry data supplied from the output point selection unit 302 (the geometry data from which the points to be output have been selected). Accordingly, the attribute decoding unit 303 supplies the geometry data and the attribute data corresponding to the selected points, to the point cloud generation unit 304.

The point cloud generation unit 304 performs a process related to generation of a point cloud. For example, the point cloud generation unit 304 acquires the geometry data and the attribute data supplied from the attribute decoding unit 303. The point cloud generation unit 304 associates the geometry data with the attribute data, to generate point cloud data.

As described above, the attribute data and the geometry data supplied from the attribute decoding unit 303 correspond to the points selected by the output point selection unit 302. That is, the point cloud generation unit 304 generates point cloud data corresponding to the points to be output.

The point cloud generation unit 304 outputs the generated point cloud data to the outside of the decoding device 300.

Note that each of these processing units (from the geometry decoding unit 301 to the point cloud generation unit 304) of the decoding device 300 has any appropriate configuration. For example, each processing unit may be formed with a logic circuit that performs the processes described above. Further, each processing unit may also include a CPU, ROM, RAM, and the like, for example, and execute a program using them, to perform the processes described above. Each processing unit may of course have both configurations, and perform some of the processes described above with a logic circuit, and the others by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Flow in a Decoding Process>

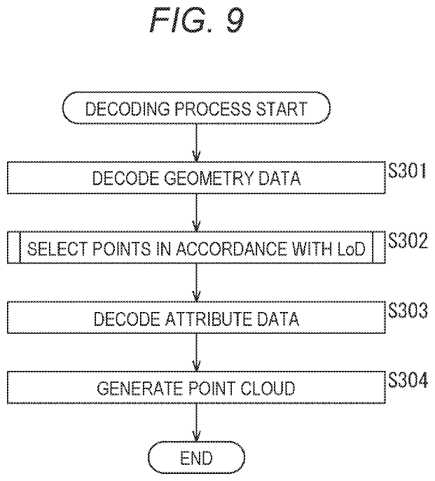

This decoding device 300 decodes encoded data by performing a decoding process. An example flow in this decoding process is now described, with reference to the flowchart shown in FIG. 9.

When the decoding process is started, the geometry decoding unit 301 decodes encoded data of geometry data, to generate (restore) geometry data in step S301.

In step S302, the output point selection unit 302 performs a point selection process, to select the number of points corresponding to the current level of detail (LoD) with respect to the geometry data generated in step S301. This point selection process can be performed in a flow similar to the flowchart shown in FIG. 5, for example.

In step S303, the attribute decoding unit 303 decodes encoded data of attribute data, to generate (restore) attribute data. This attribute data is the data corresponding to the points selected at the time of encoding. Accordingly, this attribute data corresponds to the geometry data obtained by the process in step S302. In other words, the geometry data and the attribute data correspond to the points to be output.

In step S304, the point cloud generation unit 304 generates point cloud data by associating the geometry data corresponding to the points selected in step S302 with the attribute data generated in step S303. That is, the point cloud generation unit 304 generates point cloud data corresponding to the points to be output.

When the process in step S304 is completed, the decoding process comes to an end.

By performing the decoding process as described above, the decoding device 300 can select the number of points corresponding to the current level of detail (LoD). Thus, the decoding device 300 can achieve scalability of the number of points.

<Scalability of Attribute Data>

Note that the methods for encoding/decoding attribute data are any appropriate methods. For example, attribute data may be encoded with the use of general Lifting or the like. Likewise, the encoded data of the attribute data may be decoded with the use of similar Lifting or the like.

Further, attribute data may be scalably encoded/decoded in a scalable manner. For example, by adopting the technology disclosed in Non-Patent Document 6, it is possible to scalably encode/decode attribute data.

### 5. Notes

<Computer>

The above described series of processes can be performed by hardware or can be performed by software. When the series of processes are to be performed by software, the program that forms the software is installed into a computer. Here, the computer may be a computer incorporated into special-purpose hardware, or may be a general-purpose personal computer or the like that can execute various kinds of functions when various kinds of programs are installed thereinto, for example.

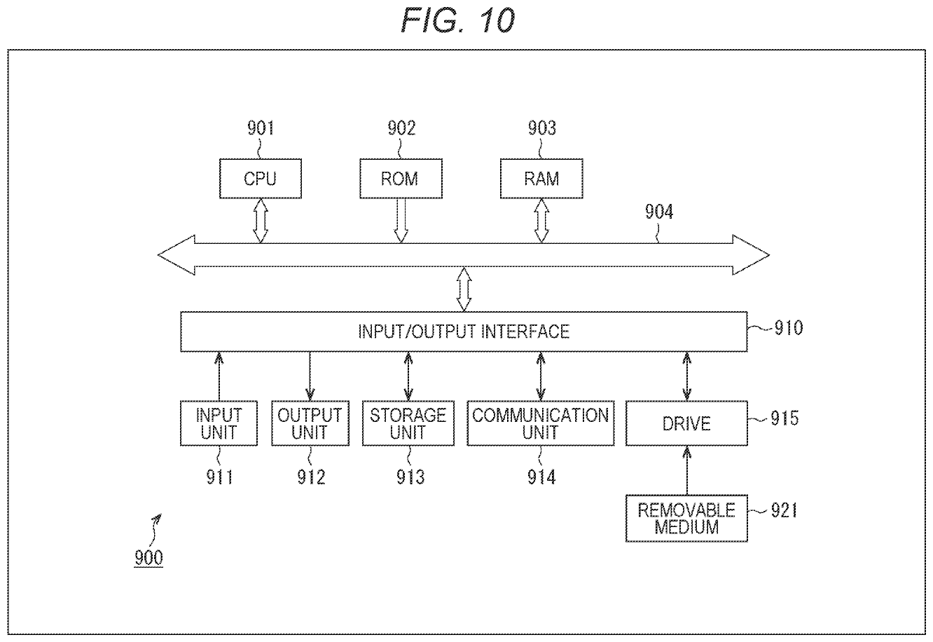

FIG. 10 is a block diagram showing an example configuration of the hardware of a computer that performs the above described series of processes in accordance with a program.

In a computer 900 shown in FIG. 10, a central processing unit (CPU) 901, a read only memory (ROM) 902, and a random access memory (RAM) 903 are connected to one another by a bus 904.

An input/output interface 910 is also connected to the bus 904. An input unit 911, an output unit 912, a storage unit 913, a communication unit 914, and a drive 915 are connected to the input/output interface 910.

The input unit 911 is formed with a keyboard, a mouse, a microphone, a touch panel, an input terminal, and the like, for example. The output unit 912 is formed with a display, a speaker, an output terminal, and the like, for example. The storage unit 913 is formed with a hard disk, a RAM disk, a nonvolatile memory, and the like, for example. The communication unit 914 is formed with a network interface, for example. The drive 915 drives a removable medium 921 such as a magnetic disk, an optical disk, a magnetooptical disk, or a semiconductor memory.

In the computer having the above described configuration, the CPU 901 loads a program stored in the storage unit 913 into the RAM 903 via the input/output interface 910 and the bus 904, for example, and executes the program, so that the above described series of processes is performed. The RAM 903 also stores data necessary for the CPU 901 to perform various processes and the like as necessary.

The program to be executed by the computer (the CPU 901) may be recorded on the removable medium 921 as a packaged medium or the like to be used, for example. In that case, the program can be installed into the storage unit 913 via the input/output interface 910 when the removable medium 921 is mounted on the drive 915.

Alternatively, this program can be provided via a wired or wireless transmission medium such as a local area network, the Internet, or digital satellite broadcasting. In that case, the program may be received by the communication unit 914, and be installed into the storage unit 913.

Also, this program may be installed beforehand into the ROM 902 or the storage unit 913.

<Targets to which the Present Technology is Applied>

Although cases where the present technology is applied to encoding and decoding of point cloud data have been described so far, the present technology is not limited to those examples, but can be applied to encoding and decoding of 3D data of any standard. That is, various processes such as encoding and decoding processes, and any specifications of various kinds of data such as 3D data and metadata can be adopted, as long as the present technology described above is not contradicted. Also, some of the processes and specifications described above may be omitted, as long as the present technology is not contradicted.

The present technology can be applied to any appropriate configuration. For example, the present technology can be applied to various electronic apparatuses, such as transmitters and receivers (television receivers or portable telephone devices, for example) in satellite broadcasting, cable broadcasting such as cable TV, distribution via the Internet, distribution to terminals via cellular communication, or the like, and apparatuses (hard disk recorders or cameras, for example) that record images on media such as optical disks, magnetic disks, and flash memory, and reproduce images from these storage media, for example.

Further, the present technology can also be embodied as a component of an apparatus, such as a processor (a video processor, for example) serving as a system LSI (Large Scale Integration) or the like, a module (a video module, for example) using a plurality of processors or the like, a unit (a video unit, for example) using a plurality of modules or the like, or a set (a video set, for example) having other functions added to units.

Further, the present technology can also be applied to a network system formed with a plurality of devices, for example. For example, the present technology may be embodied as cloud computing that is shared and jointly processed by a plurality of devices via a network. For example, the present technology may be embodied in a cloud service that provides services related to images (video images) to any kinds of terminals such as computers, audio visual (AV) devices, portable information processing terminals, and IoT (Internet of Things) devices.

Note that, in the present specification, a system means an assembly of a plurality, of components (devices, modules (parts), and the like), and not all the components need to be provided in the same housing. In view of this, a plurality of devices that is housed in different housings and is connected to one another via a network forms a system, and one device having a plurality of modules accommodated in one housing is also a system.

<Fields and Usage to which the Present Technology can be Applied>

A system, an apparatus, a processing unit, and the like to which the present technology is applied can be used in any appropriate field such as transportation, medical care, crime prevention, agriculture, the livestock industry, mining, beauty care, factories, household appliances, meteorology, or nature observation, for example. Further, the present technology can also be used for any appropriate purpose.

<Other Aspects>

Note that, in this specification, a “flag” is information for identifying a plurality of states, and includes not only information to be, used for identifying two states of true (1) or false (0), but also information for identifying three or more states. Therefore, the values this “flag” can have may be the two values of “1” and “0”, for example, or three or more values. That is, this “flag” may be formed with any number of bits, and may be formed with one bit or a plurality of bits. Further, as for identification information (including a flag), not only the identification information but also difference information about the identification information with respect to reference information may be included in a bitstream. Therefore, in this specification, a “flag” and “identification information” include not only the information but also difference information with respect to the reference information.

Further, various kinds of information (such as metadata) regarding encoded data (a bitstream) may be transmitted or recorded in any mode that is associated with the encoded data. Here, the term “to associate” means to enable use of other data (or a link to other data) while data is processed, for example. That is, pieces of data associated with each other may be integrated as one piece of data, or may be regarded as separate pieces of data. For example, information associated with encoded data (an image) may be transmitted through a transmission path different from that for the encoded data (image). Further, information associated with encoded data (an image) may be recorded in a recording medium different from that for the encoded data (image) (or in a different recording area of the same recording medium), for example. Note that this “association” may apply to part of the data, instead of the entire data. For example, an image and the information corresponding to the image may be associated with each other for any appropriate unit, such as for a plurality of frames, each frame, or some portion in each frame.

Note that, in this specification, the terms “to combine”, “to multiplex”, “to add”, “to integrate”, “to include”, “to store”, “to contain”, “to incorporate, “to insert”, and the like mean combining a plurality of objects into one, such as combining encoded data and metadata into one piece of data, for example, and mean a method of the above described “association”.

Further, embodiments of the present technology are not limited to the above described embodiments, and various modifications may be made to them without departing from the scope of the present technology.

For example, any configuration described above as one device (or one processing unit) may be divided into a plurality of devices (or processing units). Conversely, any configuration described above as a plurality of devices (or processing units) may be combined into one device (or one processing unit). Furthermore, it is of course possible to add a component other than those described above to the configuration of each device (or each processing unit). Further, some components of a device (or processing unit) may be incorporated into the configuration of another device (or processing unit) as long as the configuration and the functions of the entire system remain substantially the same.

Also, the program described above may be executed in any device, for example. In that case, the device is only required to have necessary functions (function blocks and the like) so that necessary information can be obtained.

Also, one device may carry out each step in one flowchart, or a plurality of devices may carry out each step, for example. Further, when one step includes a plurality of processes, the plurality of processes may be performed by one device or may be performed by a plurality of devices. In other words, a plurality of processes included in one step may be performed as processes in a plurality of steps. Conversely, processes described as a plurality of steps may be collectively performed as one step.

Also, a program to be executed by a computer may be a program for performing the processes in the steps according to the program in chronological order in accordance with the sequence described in this specification, or may be a program for performing processes in parallel or performing a process when necessary, such as when there is a call, for example. That is, as long as there are no contradictions, the processes in the respective steps may be performed in a different order from the above described order. Further, the processes in the steps according to this program may be executed in parallel with the processes according to another program, or may be executed in combination with the processes according to another program.

Also, each of the plurality of techniques according to the present technology can be independently implemented, as long as there are no contradictions, for example. It is of course also possible to implement a combination of some of the plurality of techniques according to the present technology. For example, part or all of the present technology described in one of the embodiments may be implemented in combination with part or all of the present technology described in another one of the embodiments. Further, part or all of the present technology described above may be implemented in combination with some other technology not described above.

Note that the present technology may also be embodied in the configurations described below.

(1) An information processing apparatus including:

a positional information decoding unit that decodes encoded data of a point cloud representing a three-dimensional object as a point group, and generates a tree structure using positional information about each of points constituting the point cloud; and

a selection unit that selects the number of nodes corresponding to a depth of a level of detail, with respect to some or all of the levels of detail constituting the tree structure.

(2) The information processing apparatus according to (1), in which

the selection unit selects the nodes so that the number of nodes to be selected in the case of a first level of detail in the tree structure becomes larger than the number of nodes to be selected in the case of a second level of detail that is shallower than the first level of detail.

(3) The information processing apparatus according to (2), in which

the selection unit selects the nodes, using pseudorandom numbers.

(4) The information processing apparatus according to (3), in which

the selection unit selects the nodes using the pseudorandom numbers, until a predetermined target number depending on the depth of the level of detail is reached.

(5) The information processing apparatus according to (4), in which

the selection unit selects the nodes using the pseudorandom numbers, until a target number corresponding to the current level of detail is reached among predetermined target numbers for the respective levels of detail.

(6) The information processing apparatus according to (4), in which

the selection unit selects the nodes using the pseudorandom numbers, until a target number corresponding to the current level of detail is reached among designated target numbers for the respective levels of detail.

(7) The information processing apparatus according to (4), in which

the selection unit selects the nodes using the pseudorandom numbers, until a target number corresponding to the current level of detail identified on the basis of a designated function is reached.

(8) The information processing apparatus according to (2), in which

the selection unit selects the nodes at which the number of nodes within a nearby region is equal to or larger than a predetermined threshold.

(9) The information processing apparatus according to (8), in which

the selection unit selects the nodes at which the number of nodes within the nearby region is equal to or larger than a threshold corresponding to the current level of detail among predetermined thresholds for the respective levels of detail.

(10) The information processing apparatus according to (8), in which

the selection unit selects the nodes at which the number of nodes within the nearby region is equal to or larger than a threshold corresponding to the current level of detail among designated thresholds for the respective levels of detail.

(11) The information processing apparatus according to (8), in which

the selection unit selects the nodes at which the number of nodes within the nearby region is equal to or larger than a threshold corresponding to the current level of detail, the threshold being specified on the basis of a designated function.

(12) The information processing apparatus according to any one of (1) to (11), further including

an attribute information decoding unit that decodes encoded data of the point cloud, and generates attribute information about the points corresponding to the positional information from which the nodes are selected by the selection unit.

(13) The information processing apparatus according to any one of (1) to (11), further including

a positional information encoding unit that encodes a tree structure using positional information about the respective points constituting the point cloud, and generates the encoded data,

in which the positional information decoding unit decodes the encoded data generated by the positional information encoding unit, and generates the tree structure.

(14) The information processing apparatus according to (13), in which

the selection unit further selects attribute information corresponding to the selected nodes, from attribute information about the respective points constituting the point cloud.

(15) The information processing apparatus according to (14), further including

an attribute information encoding unit that encodes the attribute information selected by the selection unit, and generates the encoded data.

(16) The information processing apparatus according to any one of (13) to (15), further including

a bitstream generation unit that generates a bitstream containing the encoded data generated by the positional information encoding unit, and seed information about the pseudorandom numbers to be used in selection of the nodes by the selection unit.

(17) The information processing apparatus according to any one of (13) to (15), further including

a bitstream generation unit that generates a bitstream containing the encoded data generated by the positional information encoding unit, and information regarding a target number of the nodes to be selected by the selection unit using pseudorandom numbers.

(18) The information processing apparatus according to any one of (13) to (15), further including

a bitstream generation unit that generates a bitstream containing the encoded data generated by the positional information encoding unit, and information regarding a threshold for the number of nodes within a nearby region, the information being to be used in selection of the nodes by the selection unit.

(19) The information processing apparatus according to any one of (13) to (15), further including

a bitstream generation unit that generates a bitstream containing the encoded data generated by the positional information encoding unit, and information regarding a nearby region, the information being to be used in selection of the nodes by the selection unit.

(20) An information processing method including:

decoding encoded data of a point cloud representing a three-dimensional object as a point group, and generating a tree structure using positional information about each of points constituting the point cloud; and

selecting the number of nodes corresponding to a depth of a level of detail for some or all of the levels of detail constituting the tree structure.

### REFERENCE SIGNS LIST

100 Point selection device
101 Point number setting unit
102 Pseudorandom number generation unit
103 Point selection unit
200 Encoding device
201 Geometry encoding unit
202 Geometry decoding unit
203 Point cloud generation unit
204 Output point selection unit
205 Attribute encoding unit
206 Bitstream generation unit
300 Decoding device
301 Geometry decoding unit
302 Output point selection unit
303 Attribute decoding unit
304 Point cloud generation unit

1. An information processing apparatus comprising:
a positional information decoding unit that decodes encoded data of a point cloud representing a three-dimensional object as a point group, and generates a tree structure using positional information about each of points constituting the point cloud; and
a selection unit that selects the number of nodes corresponding to a depth of a level of detail, with respect to some or all of the levels of detail constituting the tree structure.

2. The information processing apparatus according to claim 1, wherein
the selection unit selects the nodes so that the number of nodes to be selected in a case of a first level of detail in the tree structure becomes larger than the number of nodes to be selected in a case of a second level of detail that is shallower than the first level of detail.

3. The information processing apparatus according to claim 2, wherein
the selection unit selects the nodes, using pseudorandom numbers.

4. The information processing apparatus according to claim 3, wherein
the selection unit selects the nodes using the pseudorandom numbers, until a predetermined target number depending on the depth of the level of detail is reached.

5. The information processing apparatus according to claim 4, wherein
the selection unit selects the nodes using the pseudorandom numbers, until a target number corresponding to a current level of detail is reached among predetermined target numbers for the respective levels of detail.

6. The information processing apparatus according to claim 4, wherein
the selection unit selects the nodes using the pseudorandom numbers, until a target number corresponding to a current level of detail is reached among designated target numbers for the respective levels of detail.

7. The information processing apparatus according to claim 4, wherein
the selection unit selects the nodes using the pseudorandom numbers, until a target number corresponding to a current level of detail identified on a basis of a designated function is reached.

8. The information processing apparatus according to claim 2, wherein
the selection unit selects the nodes at which the number of nodes within a nearby region is equal to or larger than a predetermined threshold.

9. The information processing apparatus according to claim 8, wherein
the selection unit selects the nodes at which the number of nodes within the nearby region is equal to or larger than a threshold corresponding to a current level of detail among predetermined thresholds for the respective levels of detail.

10. The information processing apparatus according to claim 8, wherein
the selection unit selects the nodes at which the number of nodes within the nearby region is equal to or larger than a threshold corresponding to a current level of detail among designated thresholds for the respective levels of detail.

11. The information processing apparatus according to claim 8, wherein
the selection unit selects the nodes at which the number of nodes within the nearby region is equal to or larger than a threshold corresponding to a current level of detail, the threshold being specified on a basis of a designated function.

12. The information processing apparatus according to claim 1, further comprising
an attribute information decoding unit that decodes encoded data of the point cloud, and generates attribute information about the points corresponding to the positional information from which the nodes are selected by the selection unit.

13. The information processing apparatus according to claim 1, further comprising
a positional information encoding unit that encodes a tree structure using positional information about the respective points constituting the point cloud, and generates the encoded data,
wherein the positional information decoding unit decodes the encoded data generated by the positional information encoding unit, and generates the tree structure.

14. The information processing apparatus according to claim 13, wherein
the selection unit further selects attribute information corresponding to the selected nodes, from attribute information about the respective points constituting the point cloud.

15. The information processing apparatus according to claim 14, further comprising
an attribute information encoding unit that encodes the attribute information selected by the selection unit, and generates the encoded data.

16. The information processing apparatus according to claim 13, further comprising
a bitstream generation unit that generates a bitstream containing the encoded data generated by the positional information encoding unit, and seed information about the pseudorandom numbers to be used in selection of the nodes by the selection unit.

17. The information processing apparatus according to claim 13, further comprising
a bitstream generation unit that generates a bitstream containing the encoded data generated by the positional information encoding unit, and information regarding a target number of the nodes to be selected by the selection unit using pseudorandom numbers.

18. The information processing apparatus according to claim 13, further comprising
a bitstream generation unit that generates a bitstream containing the encoded data generated by the positional information encoding unit, and information regarding a threshold for the number of nodes within a nearby region, the information being to be used in selection of the nodes by the selection unit.

19. The information processing apparatus according to claim 13, further comprising
a bitstream generation unit that generates a bitstream containing the encoded data generated by the positional information encoding unit, and information regarding a nearby region to be used in selection of the nodes by the selection unit.

20. An information processing method comprising:
decoding encoded data of a point cloud representing a three-dimensional object as a point group, and generating a tree structure using positional information about each of points constituting the point cloud; and
selecting the number of nodes corresponding to a depth of a level of detail for some or all of the levels of detail constituting the tree structure.
